(19) United States
(12) Patent Application Publication
(10) Pub. No.: US 2007/0164958 A1
(43) Pub. Date: Jul. 19, 2007

(54) Active matrix liquid crystal display device

(76) Inventor: Martin J. Edwards, Crawley (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/521,672

(22) PCT Filed: Jul. 8, 2003
(86) PCT No.: PCT/IB03/03026

§ 371 Date: Jan. 18, 2005

(30) Foreign Application Priority Data
Jul. 20, 2002 (GB) 0216905.4

(51) Int. Cl. G09G 3/36

(52) U.S. Cl. 345/92

(57) ABSTRACT

An active matrix liquid crystal display device has an array of picture elements (12), each comprising a picture element electrode (14) and a switching device (16), addressed by crossing sets of selection (row) and data (column) address conductors (18,20), and a set of supplementary connection lines (30) extending in the direction of the data address conductors (20) and connected to respective ones of the row address conductors (18) enabling addressing of the array from one side or opposed sides. Each picture element includes a storage capacitor (22) connected to its picture element electrode and a capacitor line (40) shared by picture elements in the same row. The selection conductor of one row of picture elements is coupled to a respective capacitor line associated with a different row, for example via a connection line (45) at their ends, whereby each connection line is connected to a respective selection conductor for the row of picture elements and the capacitor line for another row coupled thereto. In addition to enabling unwanted display artefacts caused by spurious parasitic capacitances to be avoided, the arrangement also allows capacitively coupled drive schemes to be employed with the necessary drive signals being supplied through the connection lines.

The present invention relates to an active matrix liquid crystal display device having an array of pictures elements, each comprising a picture element electrode and a switching device, located at respective intersections between crossing sets of selection and data address conductors connected to the picture elements, and a set of connection lines for supplying selection signals to the set of selection address conductors, which connection lines extend from one side of the array in the direction of the set of data address conductors and are connected to respective ones of the set of selection address conductors.

An example of an active matrix liquid crystal display device (AMLCD) of this kind, and suitable for use in, for example, portable applications such as mobile telephones, camera view finders, electronic personal organisers and the like, is described in WO 02/063387 (PHNL 010074). In this device, each connection line extends from one side of the array to the opposite side between a respective pair of data address conductors and is connected to its associated selection address conductor at a position along its length where it extends over that conductor.

The set of connection lines connected to the set of selection (row) address conductors enables the selection (scanning) signals and display data signals applied to the data (column) address conductors to be supplied at either a common side of the array or at opposing, parallel, sides of the array rather than at two mutually perpendicular sides as in conventional AMLCDs. Hereinafter, an AMLCD having such an address architecture will be referred to as a parallel drive type AMLCD. Typically in a conventional AMLCD a set of row address conductors, carrying the selection signals, and a set of column address conductors, carrying the data signals, each extend over a rectangular support beyond the area of the array of picture elements to two adjacent, edge regions of the support, for the purpose of enabling electrical contact to be made with the sets of address conductors. For example, row and column drive circuits ICs may be directly mounted on these peripheral border regions of the support with their output terminals connected to the extended address conductors or, alternatively, may be mounted on foil with their output terminals connected to the address conductors via tracks on the foil. Using the set of connection conductor lines in the aforementioned manner enables the ICs to be provided instead either at a common peripheral border region along just one side of the support or at respective peripheral border regions along opposing, parallel, sides of the support, or alternatively for foil connections to be made at such parts.

This feature can be used, for example, to enable the effective display area for a given size of support to be increased in one dimension, which is of benefit when the display device is used in small portable products. A similar kind of connection scheme is described in the paper by R. Greene et al entitled “Manufacturing of Large Wide-View angle Seamless Tiled AMLCDs for Business and Consumer Applications”, IDMC 2000, pages 191-194. The benefit in this case is that tiling of individual display panels is facilitated by allowing the address conductors to be driven from just one edge.

It is common in AMLCDs to provide in each picture element a storage capacitor to store the applied data signal and assist in maintaining the drive voltage on the LC display element. One side of this capacitor is connected to the picture element electrode while the other side can be connected either to the selection address conductor associated with an adjacent row of picture elements or to a dedicated, supplementary, line extending parallel to the selection address conductor.

However, problems in the form of display non-uniformities can arise when using storage capacitors in the above-described kind of AMLCD.

It is an object of the present invention to provide an improved display device of the kind described in the opening paragraph.

According to the present invention, there is provided an active matrix liquid crystal display device of the kind described in the opening paragraph, wherein each picture element includes a storage capacitor connected between the picture element electrode and a capacitor line shared by the picture elements in the same row, and wherein the selection address conductor associated with one row of picture elements is coupled to the capacitor line associated with a different row of picture elements so that each connection line is connected to a respective selection address conductor for one row of picture elements and its coupled capacitor line for another row of picture elements.

The invention offers important advantages and enables the aforementioned problem of display non-uniformity to be overcome. Moreover, and equally importantly, it allows so-called capacitively coupled drive schemes to be used, again without risk of display non-uniformities being produced. Such drive schemes, wherein part of the drive voltage applied to the LC material in a picture element is coupled onto the picture element electrode via the picture element storage capacitor, are highly beneficial, particularly with regard to the design and operation of the column drive circuits used to apply the display data signals to the data address conductors, as they reduce the voltage range needed for the data signals and can lead to a reduction in the overall power consumption of the display device.

Preferably, each connection line extends from one side of the array and is connected at a connection point to the selection address conductor or the capacitor line with which it is associated that is closest to that one side of the array, and the connection line terminates at that connection point. The aforementioned display non-uniformity problems are then removed, or at least substantially reduced.

The invention follows in part from an appreciation of the causes of the display non-uniformity problems and the particular capacitive effects involved. Arranging for a selection address conductor of one picture element row to be connected to, and paired with, a storage capacitor line of a different picture element row facilitates the avoidance of such problems. Preferably the different picture element row is an adjacent picture element row. This leads to simplified connection arrangements.

A selection address conductor is preferably connected to its associated capacitor line by an interconnection between their ends at one side of the array. The location of the interconnections outside the area of the picture element array in this manner simplifies their provision and ensures that the picture element circuits themselves are unaffected, and consequently do not suffer from any additional parasitic capacitance effects as could happen if the interconnections were to be provided within the area of the array. The interconnections can be fabricated easily and conveniently at the same time as the selection address conductors and/or the capacitor lines by appropriately modifying the patterning of a deposited conductive layer used for one or other of these components.

The interconnections may all be arranged at one side of the array. Preferably, however, the interconnections associated with successive selection address conductors are arranged alternately at opposite sides of the array. Such an arrangement further simplifies fabrication and requires fewer cross-overs.

Embodiments of active matrix liquid crystal display devices (AMLCDs) according to the present invention will now be described, by way of example, with reference to the accompanying drawings, in which:

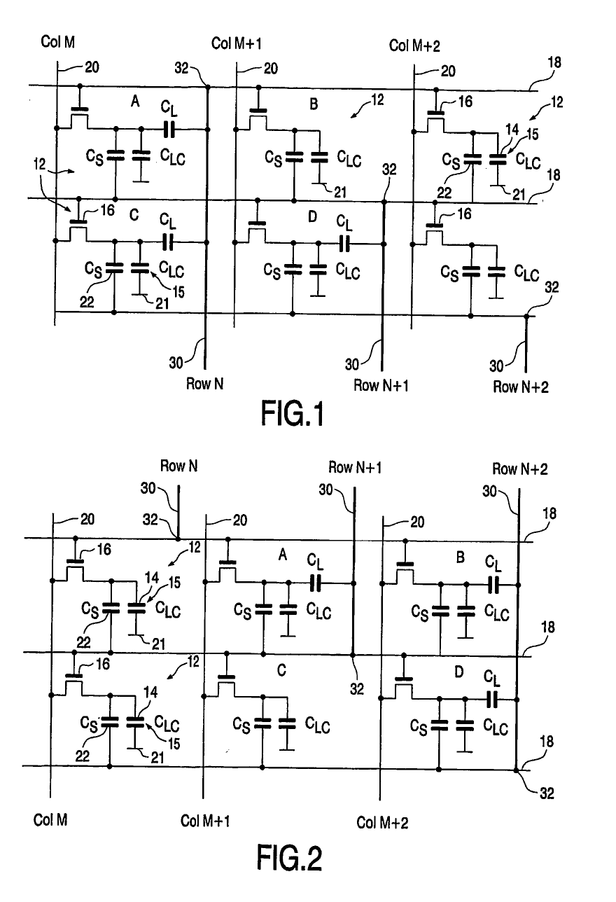

FIG. 1 illustrates schematically the equivalent electric circuit of a typical group of picture elements in a first example of a parallel drive type AMLCD;

FIG. 2 illustrates schematically the equivalent electrical circuit of a typical group of picture elements in a second example of a parallel drive type AMLCD;

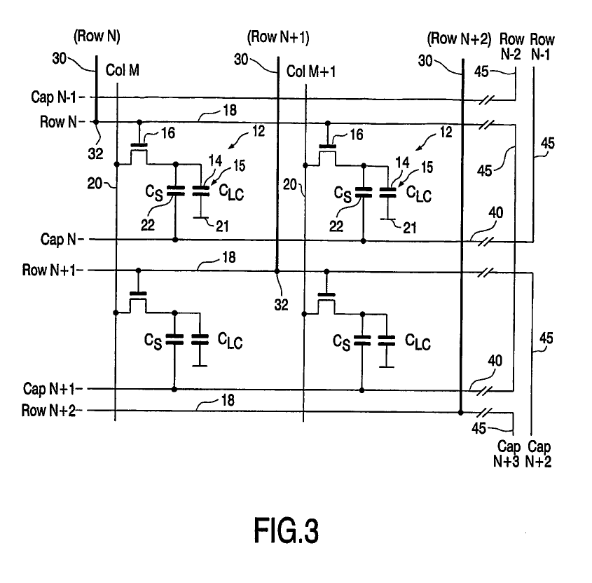

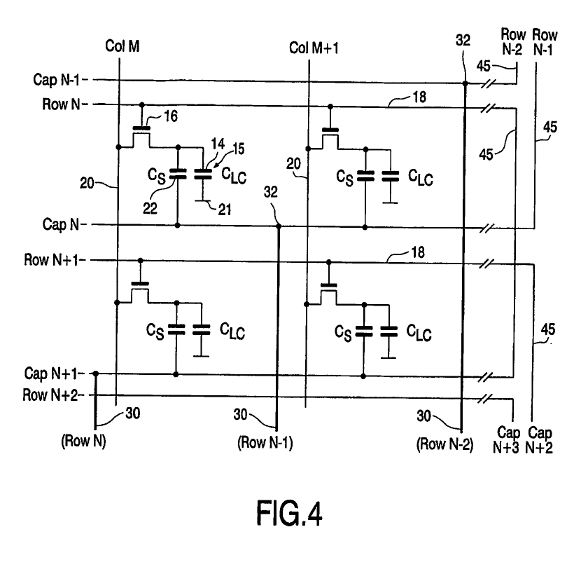

FIGS. 3 and 4 shows schematically the equivalent circuits of typical groups of picture elements in first and second embodiments of display devices according to the present invention; and

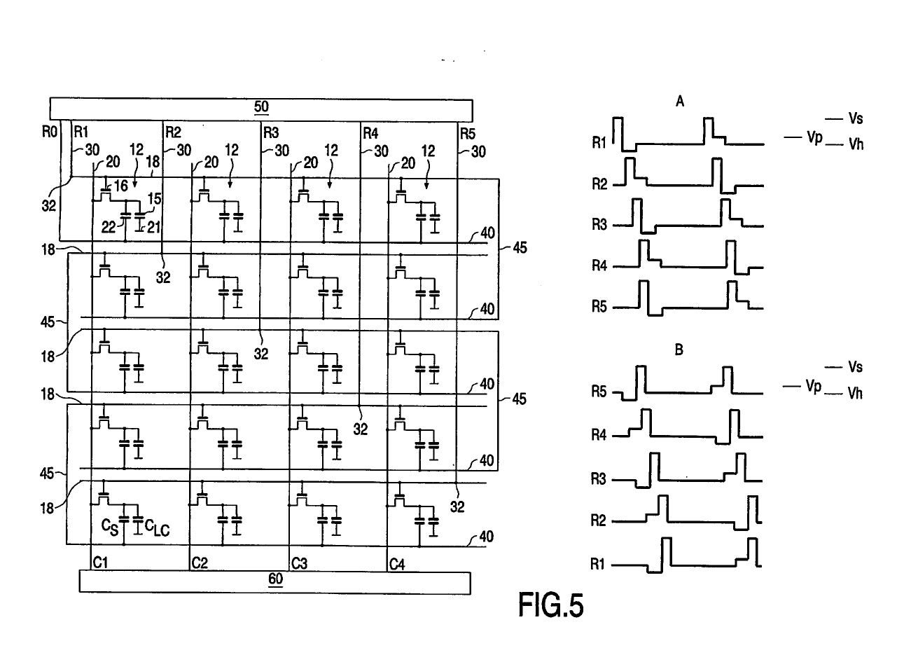

FIG. 5 shows schematically another embodiment of display device according to the present invention having, an alternative circuit configuration, together with example drive waveforms.

The same reference numbers have been used throughout the figures to denote the same or similar parts.

Referring to FIGS. 1 and 2, the first and second examples of a parallel drive array architecture type of AMLCD are generally similar to a conventional AMLCD, the main difference being that the sets of row and column address conductors are routed to opposite sides of the array (or possibly to the same side) rather than to two adjacent sides. The AMLCDs comprise an array of picture elements 12, each of which comprises a picture element electrode 14 and a switching device, here in the form of a TFT (Thin Film Transistor) 16, which is connected to respective ones of sets of row (selection) and column (data) address conductors 18 and 20. Groups of only six picture elements, in three columns Col M, Col M+1, and Col M+2, and two rows, N, N+1, are illustrated for simplicity and it will be appreciated that in a typical device there may be many thousands of picture elements in the array.

The construction of the devices follows conventional practice with the picture element electrodes 14 being organised in rows and columns and the mutually-perpendicular sets of row address conductors 18 and column address conductors 20 extending between the picture element electrodes 14 with each electrode being located adjacent the intersection of a respective pair of address conductors. The picture element electrodes, sets of address conductors and TFTs are all carried on a common support, for example a glass plate. A second, spaced, support, for example again a glass plate, is arranged overlying, and parallel to, the first support and carries a common electrode, denoted at 21 in FIGS. 1 and 2. Liquid crystal material is disposed between the supports, the liquid crystal material being contained by a seal extending around the periphery of the array between the supports. Each picture element electrode 14 together with an overlying portion of the common electrode 21 and the liquid crystal material therebetween defines a respective display element 15, here denoted as a capacitance C_{LC}.

The gate terminals of all TFTs 16 of picture elements in the same row are connected to a common row address conductor 18 to which, in operation, selection pulse (gating) signals are supplied. Likewise, the source terminals of the TFTs of all picture elements in the same column are connected to a common column address conductor 20 to which data (video) signals are applied. The drain terminals of the TFTs are each connected to a respective picture element electrode 14 forming part of, and defining, the display element.

The device is driven on a row at a time basis by scanning row conductors 18 sequentially with a selection pulse signal so as to turn on each row of TFTs 16 in turn in a respective row address period and applying data (video) signals to the column conductors for each row of display elements in turn as appropriate and in synchronism with the gating signals so as to build up over one field a complete display picture. Using one row at a time addressing, all TFTs 16 of the addressed row are switched on for a period determined by the duration of the selection pulse signal during which the data signals are transferred from the column conductors 20 the picture element electrodes 14. Upon termination of the selection signal, the conductor 18 returns to a lower, hold, level and the TFTs 16 of the row are turned off for the remainder of the frame time, thereby isolating the display elements from the conductors 20 and ensuring the applied charge is stored on the display elements until the next time they are addressed, usually in the next frame period. For more information on the general constructional and driving aspects of a typical AMLCD, reference is invited to U.S. Pat. No. 5,130,829.

Each picture element 12 also includes a storage capacitor 22, having a capacitance Cs, connected between the picture element electrode 14 and a reference potential source, which here comprises the row address conductor 18 associated with the next row of picture elements so as to allow a capacitively coupled type drive scheme to be employed in which part of the drive voltage applied to a display element upon addressing is coupled onto the electrode 14 via the storage capacitor 22. To this end a particular kind of signal waveform is applied to the row address conductors 18 comprising voltage levels in addition to the usual selection and hold levels. Capacitively coupled drive schemes are used to improve the quality of the display output, especially image sticking effects, by compensating for the dc voltage coupled onto a display element via the gate-drain capacitance of its associated TFT and to enable lower voltage column drive circuitry to be employed. They are applicable to display devices which use storage capacitors connected to an adjacent row address conductor (i.e. different to that to which the display element's TFT is connected) and which operate in a line, (row), or field inversion mode. Rather than the waveform supplied to each row address conductor comprising simply a hold level and, once per frame period, a selection (gating) pulse level which is operable to turn on the TFTs connected to that conductor in a respective row address period, the waveform used in this drive scheme further includes an intermediate step level. In operation, the display element is charged, through its associated TFT, to a certain level according to the value of the supplied data signal and after the TFT has been turned off, at the end of the selection pulse signal, to isolate the display element a voltage step of the waveform applied to the adjacent row address conductor is coupled onto the display element via the storage capacitor to take the display element voltage to a final desired level to produce a required display effect, i.e. gradation level. Thus, a step level of the waveform applied to one row address conductor contributes to the voltages obtained on the display elements in a row selected by a different, adjacent, row address conductor via their associated storage capacitors. By appropriate adjustment of the step level, this technique can be used to compensate for kickback effects.

Examples of capacitively coupled drive schemes used in TFT LC display devices are described in the paper by Takeda et al entitled “Simplified Method of Capacitively Coupled Driving for TFT-LCD” published in Proc. Japan Display 89, pages 580-583, and the paper by T. Kamiya et al entitled “A Novel Driving Method of TFT-LCD with Low Power Consumption” published in Proc. A MLCD '94, Tokyo, pages 60-62, whose disclosures are incorporated herein by reference. In the former, the storage capacitor associated with a display element is connected to the preceding adjacent row address conductor and the step level follows the selection pulse signal while in the latter the storage capacitor is connected to the succeeding adjacent row address conductor, and the step level is before the selection pulse. The terms preceding and succeeding here refer to the sequence in which the rows are addressed, usually from top to bottom.

In the device of FIG. 1, the row address conductors 18 terminate immediately adjacent opposed edges of the picture element array and a set of connection lines 30, in the form of supplementary column conductors extending in the same direction as, and parallel to, the column address conductors 20, are provided, each of which lines 30 extends from the bottom of the array between a respective adjacent pair of column address conductors 20 and terminates at a connection point 32 where it is connected to a respective one of the row address conductors 18. The supplementary connection lines 30 thus enable row selection signals to be applied to the row address conductors 18 from a lower side of the array opposite to the upper side of the array at which data signals are applied to the column address conductors 20.

To drive the picture elements, row and column drive circuits (not shown) of conventional form are connected to the sets of selection lines 30 and column address conductors 20 respectively at their one ends. The row drive circuit provides selection signals via the lines 30 to each of the row address conductors 18 in sequence to turn on each row of TFTs 16 in turn, starting with the uppermost row, and the column drive circuit provides data (video) signals, obtained for example by sampling an input video signal, to each of the column address conductors 20 in synchronism with row selection. Each row is addressed in this manner in sequence from the first, at the top, to the last, at the bottom, to build up a display output from the array. The rows are repeatedly addressed in this fashion in successive frames. The drive circuits may be provided in the form of ICs mounted on regions of the support carrying the conductors 18, 20 and 30, at opposing sides of the array. Alternatively, in the case of the TFTs comprising polysilicon devices, the drive circuits may instead be actually fabricated at opposite sides of the support using the same processes, and at the same time, as the active matrix circuitry comprising the TFTs and address conductors, etc, so as to be fully integrated on the support.

As will be appreciated therefore, driving of the device is generally similar to that of conventional AMLCDs apart from the row selection signals being applied to the row address conductors 18 via the set of lines 30. This avoids the need to dedicate peripheral portions of the support along two adjacent sides for the mounting of ICs or the provision for interconnections which has benefits in terms of the symmetry of the device and the way it can be packaged within products.

The AMLCD of FIG. 2 uses an alternative configuration of the connections of drive signals to the row address conductors but otherwise is similar to that of FIG. 1. Here, the connection lines 30 extend from the upper side of the array to their respective row address conductors 18, where they terminate at connection points 32.

The construction of the display devices will not be described here but conventional practices are generally employed. The TFTs 16 may be of amorphous, microcrystalline, or polycrystalline silicon type. The display devices may be of reflective or transmissive kind. In the former kind the connection lines 30 may be disposed beneath the picture element electrodes. In the latter kind, the connection lines 30 may be arranged to extend along one side of the picture element electrodes.

In operation of the devices of both FIGS. 1 and 2 errors in the display brightness levels of picture elements may be observed. The reasons for this will now be explained.

In the case of the device of FIG. 1, then the connection lines 30 running from the lower edge of the array beneath, or closely adjacent, the picture element electrodes 14 of their respective columns result in additional parasitic capacitances between the connection 30 and the picture element electrodes 14, as indicated at C_{L} in FIG. 1. Within most picture elements the effect of this additional capacitance is not important to the operation of the picture element. However, within, for example, the picture element labelled A in FIG. 1, the effect of the capacitance C_{L} is to increase the offset voltage that results when the TFT 16 of the picture element turns off at the termination of the selection signal applied to its associated conductor 18. This is due to the capacitance C_{L} appearing in parallel with the gate-drain capacitance of the TFT 16 within this picture element. Consequently, picture element A will have an offset voltage that is different from all the other picture elements within the same row of picture elements. This difference can result in a visible error in the brightness (grey-scale) level displayed by the picture element A. The same effect occurs also in picture element D in FIG. 1, and all other picture elements within the array at the locations of the connection points 32 between the lines 30 and the conductors 18, that is, where the line 30 carrying the row drive signals provides also the selection signal to the gate of the TFT 16 of the picture element.

In the case of the FIG. 2 configuration, in which the row drive signals are applied to the conductors 18 from above the array, the effect of the capacitance C_{L} is different to that in the device of FIG. 1 but significant when using a capacitively coupled drive scheme. In the picture element labelled A in FIG. 2 the additional parasitic capacitance C_{L} is effectively connected in parallel with the picture element's storage capacitor 22. This means that, when using capacitively coupled drive, the magnitude of the drive voltage coupled onto the electrode 14 of picture element A will be greater than for other picture elements in the same row causing this picture element to have to a different brightness level. The same effect occurs in the picture element labelled D and similarly in all other picture elements located adjacent the connection points 32 and in which the connection line 30 carries the signal for its storage capacitor 22.

FIGS. 3 and 4 show the circuit configurations of two example embodiments of AMLCDs according to the present invention which avoid these problems with brightness errors. Only four picture elements 12 are shown in each case for simplicity, in two rows, Row N, Row N+1, and two columns, Col M, Col M+1. Both examples use modified array architecture in which the connection lines 30 do not pass through picture elements 12 for which they provide either the selection signal for the TFT 16 or the drive signal for the storage capacitor 22. Instead, the lines 30 each terminate close to the edge of the picture element for which it provides either the selection signal or the capacitor line drive signal that is closest to the side of the array from which the connection line extends to minimise the additional capacitance CL between the line 30 and the picture element electrode 14.

This is achieved by using separate horizontal electrodes for the row address conductors 18 and for the storage capacitors 22, rather than using the same conductor for both purposes as before. Thus, the devices have a set of row address conductors 18 and a separate set of storage capacitor lines 40 (cap N, Cap N+1, etc) extending parallel with the row address conductors. The row address conductor 18 and storage capacitor line 40 for an individual row of picture elements are located at opposite sides of the picture element, for example with the row address conductor being towards the top of the picture element and the capacitor line being towards the bottom of the picture element, or vice versa. Each row drive signal carried by a connection line 30 connected to a respective row address conductor 18 is used to provide the selection (TFT gating) signals for the associated row of picture elements and the storage capacitor drive signals for a second, different, row of picture elements. To this end, the row address conductor 18 and capacitor line 40 concerned are connected together as a pair, by means of a short, vertical, interconnection 45 linking the conductor 18 and the line 40 at their ends at one side of the array outside the display area. The row address conductors and the capacitor lines for all the picture elements in the array are paired and linked together in this manner. In principle, the row address conductor and capacitor line paired together do not need to be adjacent one another but if they are then the lay-out of the required linking interconnections at the edge of the array is simplified.

The externally generated row drive signals can be supplied on the vertical connection lines 30 from either below (FIG. 4) or above (FIG. 3) the array, as with the configurations of FIGS. 1 and 2 respectively. Where a particular connection line 30 meets the first of either the row address conductor 18 or the capacitor line 40 to which it must be connected, i.e. the conductor or line closest to the side of the array from which the connection lines run, the line 30 is connected to that conductor or line and terminates at that point. The required connection between that conductor or line and its paired line or conductor respectively which must carry the same row drive signal is effected through the interconnection at the array edge. This avoids the need for the line 30 carrying the row drive signal to pass through any of the picture elements for which it provides drive signals.

With regard to the FIG. 3 configuration then the connector lines 30 meet first the row address conductors 18 of those pairs of address conductors and capacitor lines with which they are associated and to which they supply drive signals. For example, the connection line 30 carrying the row drive signal for switching the TFTs 16 of the picture elements 12 in the Nth row is connected at point 32 to the Row N address conductor 18. This signal is connected to the capacitor line Cap N+1 of the next, N+1th, row of picture elements via the interconnection 45 linking the end of that line with the Row N address conductor 18. Similarly, the connection line 30 for supplying drive signals to the Row N+1 row address conductor 18 for the N+1th row are supplied to the capacitor line 40 for the N+2th row of picture elements via an interconnection 45, and so on. It will be appreciated that the interconnections 45 at the side of the array avoid the need for the line 30 to pass to the appropriate capacitor line through the picture elements with which it is associated.

In the FIG. 4 configuration, the connection lines 30 coming from below the array first meet the capacitor lines 40 of the respective row address conductor 18/capacitor line 40 pair to which the signals they carry must be supplied. Each connection line 30 terminates at its respective capacitor line 40, where it is connected to the capacitor line by a connection point 32, and the drive signals on the line 30 are supplied to the associated row address conductor 18 through an interconnection 45 at the side of the array linking the capacitor line 40 to that row address conductor 18. Thus, for example, the connection line 30 providing drive signals for the storage capacitors of the picture elements in the N+1th row and the TFTs 16 of the picture elements in the Nth row is connected to the capacitor line cap N+1 of the N+1th row of picture elements which is connected at its end via an interconnection 45 to the Row N row address conductor 18, and so on.

In both configurations, it will be apparent that the aforementioned effects of the capacitances C_{L} at certain picture elements are no longer present, and hence the kind of unwanted display non-uniformities previously found are avoided.

In the devices of both FIGS. 3 and 4, the interconnections 45 between respective pairs of capacitor lines 40 and row address conductors 18 need not be located at only one side of the array. In FIG. 5 there is shown schematically part of the circuit arrangement of an alternative configuration of AMLCD, comprising for simplicity an array consisting of five rows, R1-R5, and four columns, C1-C4, of picture elements, in which the row drive signals are supplied by a row drive circuit 50 from the top, via connecting lines 30 as in the FIG. 3 embodiment, and in which the data signals for the picture elements are supplied to the column address conductors 20 by a column drive circuit 60 at the bottom of the array. In this arrangement, the interconnections 45 between successive pairs of associated row address conductors 18 and capacitor lines 40 are provided alternately on opposite sides of the array rather than being all located at just one side. As a consequence, fewer conductor cross-overs are entailed.

As is apparent from FIG. 5, the capacitor line 40 of the first row of picture elements is not paired with a row address conductor 18. In practice, this first row may be a dummy row masked from view and not forming part of the display output. Alternatively, the capacitor line 40 may simply be connected to a dedicated output R₀ of the row drive circuit 50, as shown.

FIG. 5 also illustrates examples of the row drive signal waveforms applied to the connection lines for successive rows in a typical capacitively coupled drive scheme. Those shown at A are appropriate to the rows of picture elements being scanned and addressed in sequence from the top to the bottom, while those shown at B are appropriate to the rows being scanned and addressed in sequence from the bottom to the top. The signal waveform applied to each connection line 30, and thus to the row address conductor 18 and capacitor line 40 connected to that line 30, comprises a selection (gating) signal level Vs that turns on the TFTs 16 coupled to the row address conductor 18 concerned during a row address period such that the picture element electrodes 14 of a row of picture elements are charged according to the level of the data signals applied simultaneously to their respective column address conductors 20, and a hold (non-selection) signal level Vh which maintains the TFTs 16 in their off state following the addressing of the picture elements so as to isolate the electrodes 14 from the column conductors. Immediately following or preceding the selection signal Vs in the waveform for one row in A and B respectively, there is an additional level Vp which coincides with the selection signal component of the row drive waveform for the adjacent row of picture of elements and this additional level Vp contributes, by coupling through the storage capacitors of the picture elements in that adjacent row, to the voltage established on the picture elements electrodes 14 of that row. As can be seen, the signal Vp is inverted for successive frames since it is required to reverse the polarity of the drive voltage applied to the LC display elements in successive frames. The row drive signal waveform in this capacitively coupled drive scheme thus comprises four levels.

In the above-described embodiments, the connection lines 30 are arranged to terminate at the connection points to their respective associated row address conductor 18 or capacitor line 40. However, as the capacitive environment for picture elements before and after the connection points consequently differ, certain unwanted display artefact effects may be produced, as described in WO 03/014808 (PHGB 010132). It may be desired, therefore, to use complementary conductor lines extending from adjacent the connection points to the opposite side of the array to that from which the connection lines run and which are electrically separate from the connection lines and held at a reference potential in order to avoid or reduce such problems as described in the aforementioned specification.

While generally rectangular picture element arrays are used in the above described embodiments, it is envisaged that the array may be of a different shape, for example semi-circular. The ability to provide row and column drive circuits, or connection regions therefor, along the same side or opposing sides of the array, allows greater freedom in the choice and implementation of array shapes utilised.

From reading the present disclosure, other modifications will be apparent to persons skilled in the art. Such modifications may involve other features which are already known in the field of active matrix display devices and component parts therefor and which may be used instead of or in addition to features already described herein.

1. An active matrix liquid crystal display device having an array of pictures elements, each comprising a picture element electrode and a switching device, located at respective intersections between crossing sets of selection and data address conductors connected to the picture elements, and a set of connection lines (30) for supplying selection signals to the set of selection address conductors, which connection lines extend from one side of the array in the direction of the set of data address conductors and are connected to respective ones of the set of selection address conductors, wherein each picture element includes a storage capacitor connected between the picture element electrode and a capacitor line shared by the picture elements in the same row, and wherein the selection address conductor associated with one row of picture elements is coupled to the capacitor line associated with a different row of picture elements so that each connection line is connected to a respective selection address conductor for one row of picture elements and its coupled capacitor line for another row of picture elements.

2. A device according to claim 1, wherein the selection address conductor associated with one row of picture elements is coupled to the capacitor line associated with an adjacent row of picture elements.

3. A device according to claim 1, wherein a selection address conductor and a capacitor line are coupled by an interconnection between their ends at one side of the array.

4. A device according to claim 3, wherein the interconnections for successive selection address conductors and their respective associated capacitor lines are arranged alternately at opposite sides of the array.

5. A device according to any one of the preceding claims, wherein each connection line extends from one side of the array and is connected at a connection point (to the selection address conductor (18) or the capacitor line (40) with which it is associated that is closest to that side, and wherein the connection line (30) terminates at that connection point.

6. A device according to any one of the preceding claims, wherein the capacitor line and selection address conductor associated with one row of picture elements extend along opposite sides of the row of picture elements.

7. A device according to any one of the preceding claims, wherein the picture element array is driven using a capacitively coupled drive scheme in which part of the drive voltage applied to the picture element electrode is provided via the storage capacitor.
